(19) United States
(12) Patent Application Publication
(10) Pub. No.: US 2010/0147833 A1
(43) Pub. Date: Jun. 17, 2010

(54) Method and Apparatus for Induction Heating of a Metallic Workpiece

(75) Inventors: Carsten Buehrer, Bonn (DE); Jens Mueller, Bonn (DE)

Correspondence Address: EDELL, SHAPIRO & FINNAN, LLC, 1901 RESEARCH BOULEVARD, SUITE 400, ROCKVILLE, MD, 20850, US

(73) Assignee: ZENERGY POWER GMBH, Rheinbach (DE)

(21) Appl. No.: 12/709,663

(22) Filed: Feb. 22, 2010

Related U.S. Application Data
(63) Continuation of application No. PCT/EP2008/006333, filed on Jul. 31, 2008.

(30) Foreign Application Priority Data
Aug. 23, 2007 (DE) 102007039888.5

(51) Int. Cl. H05B 6/04; H05B 6/36

(52) U.S. Cl. 219/647; 219/672; 219/660

(57) ABSTRACT

An apparatus and related method for inductively heating a workpiece is disclosed. A first magnetic unit is rotated about a metallic workpiece utilizing a super-conducting spool, while a second magnetic unit can be utilized to generate an exterior magnetic field operable to drive the first magnetic unit.

### CROSS REFERENCE TO RELATED APPLICATIONS

This application is a continuation of International Application No. PCT/EP2008/006333, filed on Jul. 31, 2008, entitled “Method and Device for Induction Heating of a Metallic Workpiece,” which claims priority under 35 U.S.C. §119 to Application No. DE 102007039888.5 filed on Aug. 23, 2007, entitled “Method and Device for Induction Heating of a Metallic Workpiece,” the entire contents of which are hereby incorporated by reference.

### FIELD OF THE INVENTION

The invention is directed toward induction heating of workpieces with a super conducting (SC) coil.

### BACKGROUND

Processes for heating a workpiece with a superconducting coil are generally known. In order to heat a metallic workpiece, a magnetic field is produced utilizing an HTSC coil into which the workpiece is introduced. The workpiece and the HTSC coil (through which direct current flows and which generates the magnetic field) are rotated relative to one another so that a temporally changing magnetic field acts on the workpiece. A current is thus induced in the workpiece. As a result of the ohmic resistance of the workpiece, the current heats the workpiece to a desired temperature. The rotary drive is usually provided utilizing a separate electric motor that is mechanically coupled with the HTSC coil or the workpiece. The power introduced into the workpiece can reach a few 100 kW, which requires respective complex and high-maintenance constructions.

### SUMMARY OF THE INVENTION

The invention relates to a method and apparatus for rotating a first magnetic unit with at least one superconducting (SC) coil, e.g. a high-temperature superconducting coil (HTSC), about a metallic workpiece to be heated inductively, and a respective apparatus. In accordance with the invention, an exterior magnetic field is generated by a second magnetic unit, which exterior magnetic field interacts with a magnetic field generated by the first magnetic unit, so that the first magnetic unit is rotated by the workpiece to be heated inductively. As a result, the separate electric motor and the drive mechanism (which are necessary in convention systems) can be omitted. In addition, the heat introduction into the SC coil via the mechanical connection of the SC coil with the motor is avoided.

One embodiment of the invention can also be described as an electric motor with a rotor, which includes a receptacle for the workpiece that is concentric to the rotational axis of the rotor and which carries a superconducting (SC) coil. The rotor corresponds to the first magnetic unit. The second magnetic unit corresponds to the stator of the electric motor and generates a revolving magnetic field for driving the rotor.

The magnetic field generated by the second magnetic unit is rotated about the rotational axis of the first magnetic unit. This leads to high efficiency. By way of example, the second magnetic unit may comprise coils which are arranged about the first magnetic unit and are subjected to alternating current which generates a magnetic field that rotates about the rotational axis of the first magnetic unit.

Permanent magnets and/or coils of the second magnetic unit through which direct current flows can be alternatively rotated to generate the magnetic field that drives the first magnetic unit. Although an electric motor with a mechanism for driving the permanent magnets or the coils through which direct current flows are required in such a method (which is present in conventional systems), the method of the present invention offers the advantage over a drive of the first magnetic unit according to the state of the art that the first magnetic unit and thus the superconducting (SC) coil are not coupled in a rigid manner via a gear or the like with the electric motor, so that the introduction of heat into the SC winding via the drive mechanism necessary according to the state of the art is avoided.

Preferably, the SC coil is fed with direct current, especially by a constant current source. The necessary cooling power can thus be reduced in comparison with feeding the SC coil with alternating current. The coil can also be short-circuited after an initial supply with current. The current through the SC coil then remains substantially constant.

An apparatus for performing the method includes a first magnetic unit which is rotatable about a metallic workpiece which is clamped in a workpiece holder. The first magnetic unit comprises at least one SC coil, typically made of a strip-like HTSC, with a magnetic field generated by the first magnetic unit penetrating the workpiece. The apparatus includes a second magnetic unit for the rotary drive of the first magnetic unit, which second magnetic unit generates a magnetic field rotating about the rotation axis of the first magnetic unit. The SC coil is preferably connected to a constant current source.

Preferably, the first magnetic unit comprises a recess which is concentric to its rotational axis and in which the workpiece to be heated can be introduced. This enables the poles of several SC coils about the recess, which coils belong to the first magnetic unit, and thus about a workpiece introduced into the same and thus generating a respectively larger magnetic flux density in the workpiece.

In a preferred embodiment, the second magnetic unit includes at least two, preferably three or more coils which are stationary in relation to the workpiece holder and are subjected to an electric alternating field. As a result, the magnetic field rotating about the rotational axis of the first magnetic unit can be generated in a simple way.

In a further embodiment, the second magnetic unit comprises permanent magnets and/or DC-supplied coils, e.g. HTSC coils, which are rotationally driven about the rotational axis of the first magnetic unit, e.g. by an electric motor.

The first magnetic unit may include permanent magnets that are connected in a torsion-proof manner with the SC coil, which permanent magnets are preferably arranged between the SC coil and the second magnetic unit. In such a magnetic unit, the permanent magnets interact with the exterior magnetic field generated by the second magnetic unit, with the SC coil being used substantially for generating the magnetic field penetrating the workpiece. The first magnetic unit can also have one or several coils instead of the permanent magnets. The coils can be supplied with direct current, whereupon the rotational drive occurs according to the principle of a synchronous motor. If the coils are metallic and short-circuited, then the rotational drive occurs according to the principle of an asynchronous motor.

It is understood that the first magnetic unit can have several SC coils, e.g. two or four, which are preferably arranged equidistantly about the recess of the first magnetic unit to accommodate the workpiece to be heated. As a result, the magnetic flux penetrating the workpiece, and thus the heating performance, can be increased.

A thermal insulation layer is preferably positioned between the superconducting (SC) coil and the second magnetic unit. The necessary cooling capacity for the SC coil is thus reduced. Permanent magnets can be arranged on the outer circumference of the insulation layer whose magnetic field, as already explained above, interacts with the exterior magnetic field of the second magnetic unit in order to rotate the first magnetic unit about the workpiece to be heated.

The insulation can be achieved for example by an evacuated cavity between the first and the second magnetic unit. It is additionally or alternatively appropriate to insulate the SC coil or SC coils also on the side of the workpiece, e.g., by an evacuated cavity.

The workpiece holder may be configured to move, e.g., parallel to the rotational axis of the first magnetic unit. The direction of the current induced in the workpiece can be varied by an additional relative movement between workpiece and the first magnetic unit through a linear actuator, enabling a more even heating of the workpiece and higher introduction of power.

As high temperature superconductors (HTSC), various rare-earth/Cu superconductors (such as YBa₂Cu₃O₇₋ₓ (YBCO)) may be utilized. Typically, high temperature superconductors (HTSC) have a superconducting (SC) transition temperature above 77K.

### BRIEF DESCRIPTION OF THE DRAWINGS

FIG. 1 illustrates an apparatus for induction heating in accordance with an embodiment of the invention.

FIG. 2 illustrates a perspective view of the magnetic system in accordance with an embodiment of the invention.

FIG. 3 illustrates a cross sectional view of the magnetic system shown in FIG. 1.

FIG. 4 illustrates a partial view in close-up of the detail c of FIG. 3.

FIG. 5 illustrates a perspective view of a magnetic system in accordance with another embodiment of the invention.

FIG. 6 illustrates a cross-sectional view of the magnetic system of FIG. 5.

FIG. 7 illustrates a partial view in close-up of the detail c of FIG. 6.

Like reference numerals have been used to identify like elements throughout this disclosure.

### DETAILED DESCRIPTION OF THE INVENTION

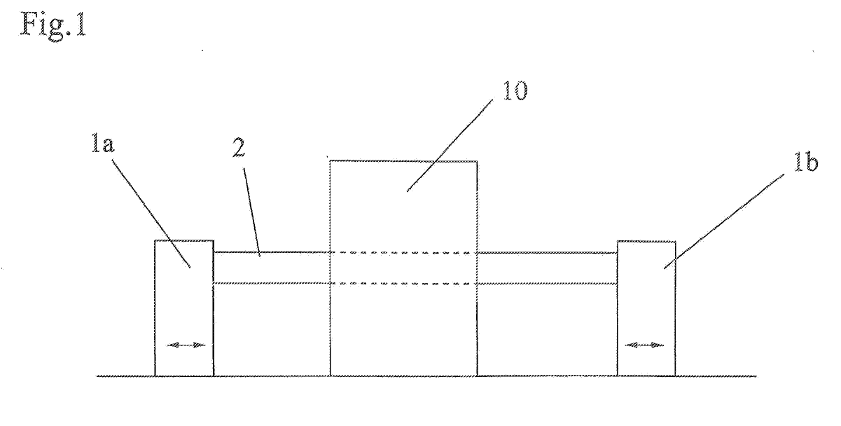

Referring to FIG. 1, an induction heating apparatus comprises a workpiece holder which is displaceable in the direction of the double arrows and comprises two receptacles 1a, 1b for fixing a workpiece 2 to be heated. A magnetic system 10 with a recess for the workpiece 2 for generating a temporally non-constant magnetic flux through the workpiece 2 is disposed between the receptacles 1a, 1b, through which a current is induced in the workpiece 2.

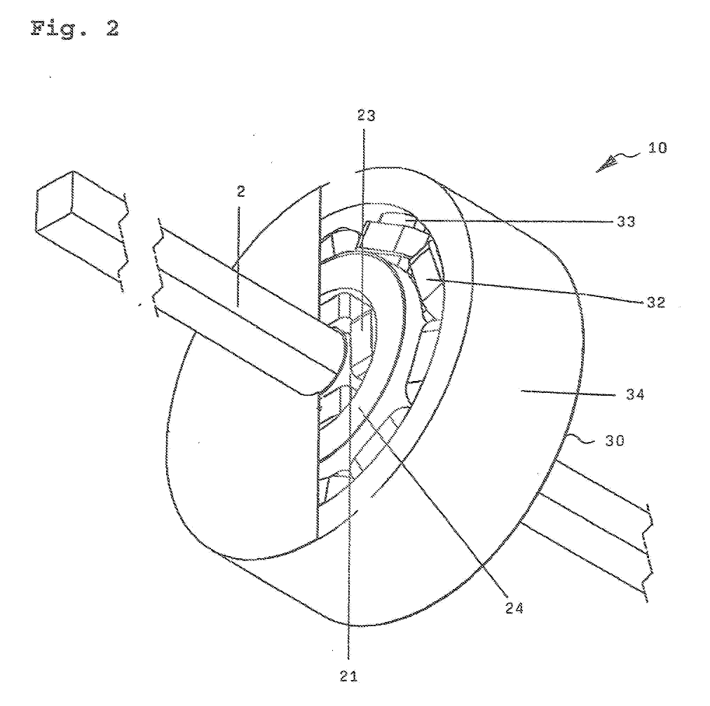

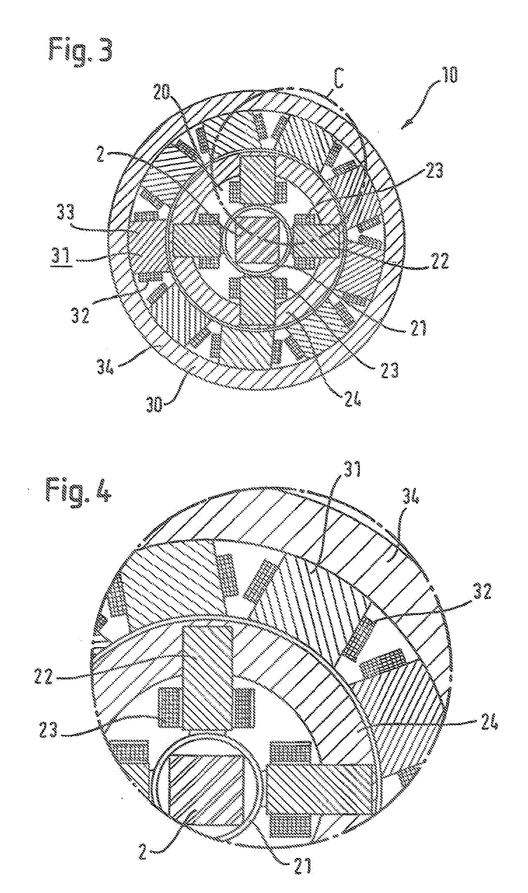

FIGS. 2 to 4 show an embodiment of a magnetic system 10. A workpiece 2 which is square in its cross section is disposed in the center of the magnetic system 10. A first magnetic unit 20 which is rotatable about the workpiece 2 and comprises a first annular insulation 21 is disposed concentrically about the workpiece, with the free inner space of said insulation simultaneously forming the recess for the workpiece 2. Four iron cores 22 are arranged in an equidistant manner about the first insulation 21, with the longitudinal axes of the iron cores (not shown) intersecting in a point with the longitudinal axis (not shown) of the first insulation 21. An HTSC coil 23 sits on each iron core 22. The HTSC coils 23 are supplied with direct current (not shown). A second annular insulation 24 is provided about the coils 23, with the iron cores 22 immersing in said insulation (FIG. 4).

The first magnetic unit 20 is enclosed concentrically by a second magnetic unit 30. The second magnetic unit 30 includes a plurality of electromagnets 31 (e.g., about nine electromagnets), each having a coil 32 on a pole shoe 33. The electromagnets 31 can be triggered individually and comprise an annular magnetic keeper 34. A magnetic field which rotates relative to the workpiece 2 is generated by a revolving triggering of the electromagnets 31, which magnetic field cooperates with the magnetic field of the DC-supplied HTSC coils 23 of the first magnetic unit 20 and rotates the first magnetic unit 20 about the workpiece. This leads to a change in the magnetic flux through the workpiece 2 which is generated by the HTSC coils 23, through which a current is induced in the workpiece 2.

Since the iron cores 22 immerse in the second insulation 24 until shortly before their outer edge, a good magnetic coupling of the first magnetic unit 20 with the second magnetic unit 30 is obtained, which, in turn, provides a device of high efficiency.

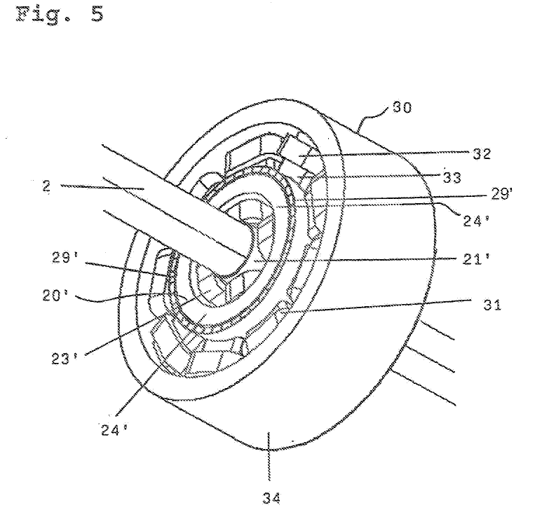

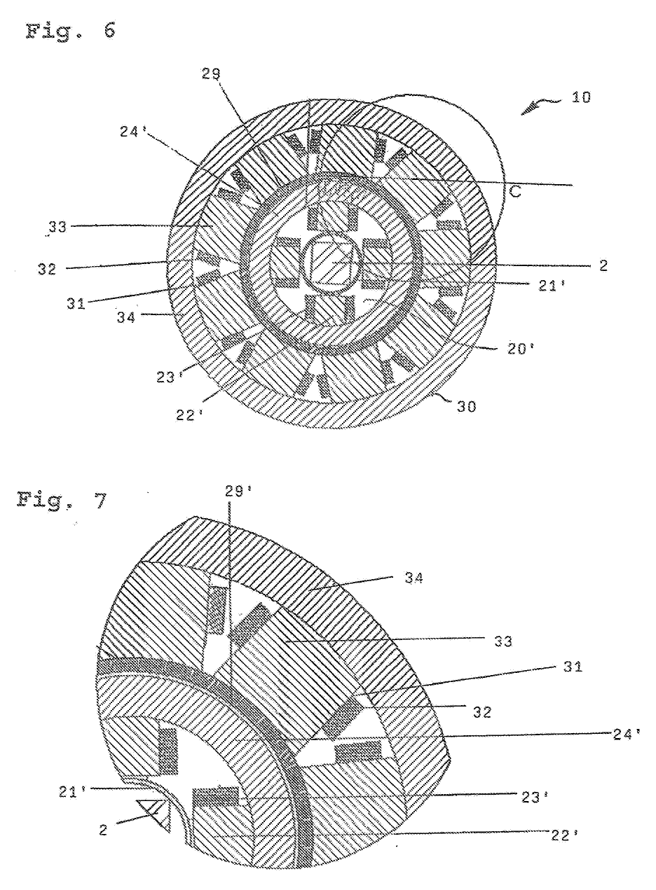

FIGS. 5 to 7 show a further embodiment of a magnetic system 10. The principal configuration of the magnetic system 10 is similar to the one described above in connection with FIGS. 2, 3 and 4, which is why identical reference numerals are used for the same parts and merely the differences will be described. As with the previous embodiment, the system includes a first annular insulation 21′ and a second annular insulation 24′. In contrast to the magnetic system according to FIG. 2, however, the iron cores 22′ of the HTSC coils 23′ do not immerse in the second annular insulation 24′ (also see FIGS. 6 and 7). The thermal insulation of the HTSC coils 23′ can thus be improved. Permanent magnets 29′ are fastened to the jacket surface of the insulation 24′ for magnetically coupling the first magnetic unit 20′ with the second magnetic unit 30. The rotary drive of the first magnetic unit 20′ occurs by applying an alternating current to the coils 32 of the second magnetic unit 30, as in the embodiment according to FIG. 2. However, the magnetic field of the coils 32 cooperates here substantially with the magnetic field of the permanent magnets 29′, through which the first magnetic unit 20′ is rotationally driven.

A magnetic keeper 34 (e.g., an iron ring) can be disposed between the insulation 24′ and the iron core 22′.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention that come within the scope of the appended claims and their equivalents.

what is claimed is:

1. A method for induction heating of a workpiece, the method comprising:
(a) rotating a first magnetic unit with at least one superconducting coil about the workpiece, wherein the first magnetic unit rotates about a rotational axis; and
(b) generating a magnetic field with a second magnetic unit, wherein the magnetic field rotates about the rotational axis of the first magnetic unit and drives the first magnetic unit.

2. The method according to claim 1, wherein:
the second magnetic unit includes a plurality of coils;
the coils of the second magnetic unit are arranged about the first magnetic unit; and
(b) further comprises (b.1) supplying the coils of the second magnetic unit with alternating current to generate the magnetic field.

3. The method according to claim 1, wherein permanent magnets and/or at least one coil of the second magnetic unit through which direct current flows are rotated about the rotational axis of the first magnetic unit to generate the magnetic field.

4. The method according to claim 1, further comprising (c) supplying the superconducting coil with direct current.

5. An apparatus for induction heating of a workpiece clamped in a workpiece holder, the apparatus comprising:
a first magnetic unit having a rotational axis, the first magnetic unit including at least one superconducting coil, wherein the first magnetic unit is rotatable about the workpiece, and wherein the superconducting coil generates a magnetic field that penetrates the workpiece; and
a second magnetic unit to generate a magnetic field that rotates about the rotational axis of the first magnetic unit in order to rotate the first magnetic unit about the workpiece.

6. The apparatus according to claim 5, wherein the superconducting coil is connected to a constant current source.

7. The apparatus according to claim 5, wherein the first magnetic unit further comprises a recess into which the workpiece is introduced.

8. The apparatus according to claim 7, wherein the first magnetic unit comprises at least two superconducting coils are arranged in an approximately equidistant manner about the recess.

9. The apparatus according to claim 5, wherein the second magnetic unit comprises at least two coils which are stationary relative to the workpiece holder and are supplied with an alternating current.

10. The apparatus according to claim 5, wherein the second magnetic unit comprises a plurality of permanent magnets and/or at least one DC-supplied coil which are rotationally driven about the rotational axis of the first magnetic unit.

11. The apparatus according to claim 5, wherein:
the first magnetic unit comprises permanent magnets coupled to the superconducting coil in a torsion-proof manner; and
the permanent magnets are arranged between the superconducting coil and the second magnetic unit.

12. The apparatus according to claim 5 further comprising a thermal insulation device arranged between the superconducting coil and the second magnetic unit.

13. The apparatus according to claim 12, wherein the thermal insulation device comprises an evacuated cavity disposed between the superconducting coil and the second magnetic unit.

14. The apparatus according to claim 5 further comprising a workpiece holder driven by thrust oriented parallel to the rotational axis of the first magnetic unit.
